(19) United States
(12) Patent Application Publication
(10) Pub. No.: US 2011/0262579 A1
(43) Pub. Date: Oct. 27, 2011

(54) IMPRINTING MOLD AND IMPRINTING MOLDING METHOD

(75) Inventor: HSIANG-HUNG CHEN, Tu-Cheng (TW)

(73) Assignee: HON HAI PRECISION INDUSTRY CO., LTD., Tu-Cheng (TW)

(21) Appl. No.: 12/862,776

(22) Filed: Aug. 25, 2010

(30) Foreign Application Priority Data
Apr. 23, 2010 (TW) 99112754

(51) Int. Cl. B28B 11/08

(52) U.S. Cl. 425/385

(57) ABSTRACT

An imprinting mold includes a mold body including a top molding surface, an air flue formed through the mold body, and a breathable member. The air flue includes a first end exposed at the top molding surface, and a second end. The breathable member is filled in the first end of the air flue. The breathable member has an exposed surface smoothingly adjoining the molding surface. An imprinting molding method using the imprinting mold is also provided.

### BACKGROUND

1. Technical Field

The present disclosure relates to molds, and particularly to an imprinting mold and an imprinting molding method using the imprinting mold.

2. Description of Related Art

Air bubbles in molding materials easily lead to waste. In particular, in an imprinting molding, air exists in the imprinting mold and molding materials during delivering the molding materials to the imprinting mold.

What is needed, therefore, is an imprinting mold and an imprinting molding method, which can overcome the above shortcomings.

### BRIEF DESCRIPTION OF THE DRAWINGS

Many aspects of the present imprinting mold and imprinting molding method can be better understood with reference to the following drawings. The components in the drawings are not necessarily drawn to scale, the emphasis instead being placed upon clearly illustrating the principles of the present imprinting mold and imprinting molding method. Moreover, in the drawings, like reference numerals designate corresponding parts throughout the several views.

FIG. 1 is a schematic view of an imprinting mold in accordance with a first embodiment.

FIG. 2 is a cross-sectional view of the imprinting mold of FIG. 1, taken along line II-II.

FIG. 3 is a cross-sectional view of an imprinting mold in accordance with a second embodiment.

FIG. 4 shows an exemplary imprinting molding method using the imprinting mold of FIG. 1.

### DETAILED DESCRIPTION

Embodiments of the present imprinting mold and imprinting molding method will now be described in detail below and with reference to the drawings.

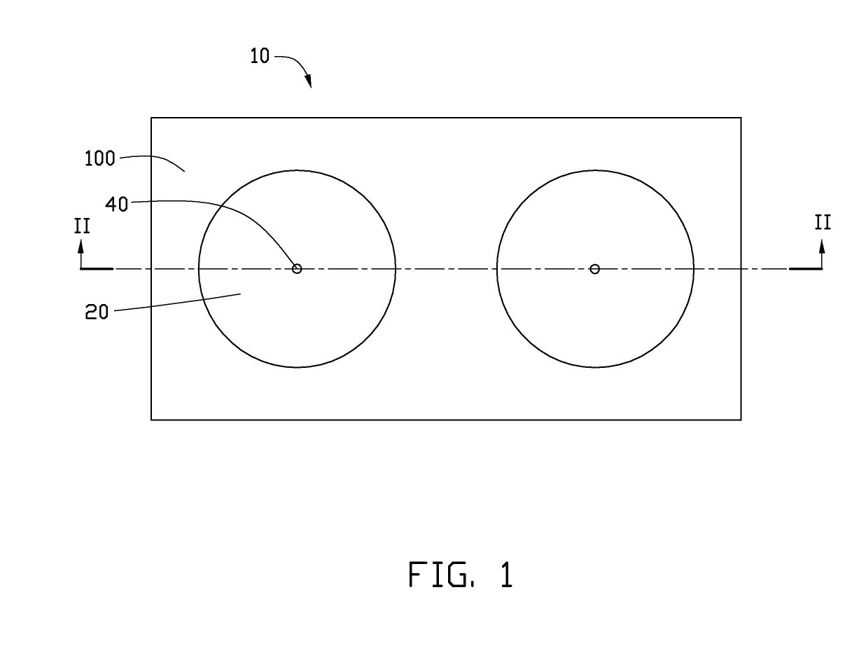

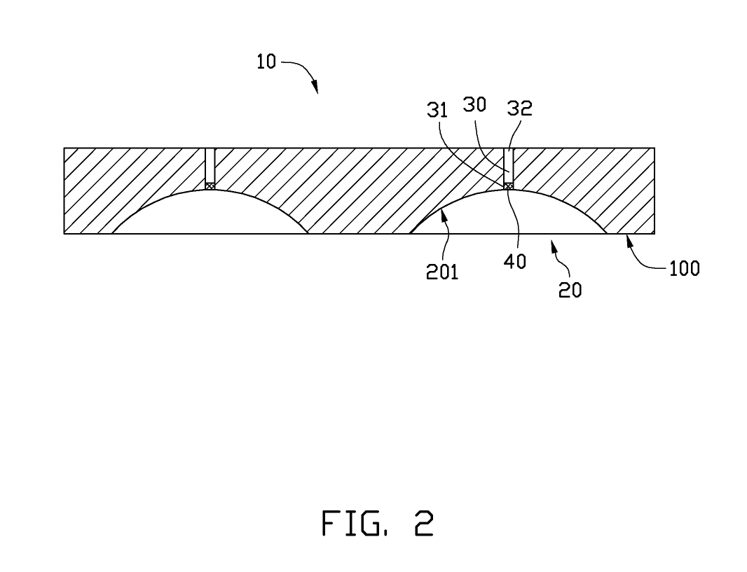

Referring to FIGS. 1 and 2, an imprinting mold 10 in accordance with a first embodiment, is provided. The imprinting mold 10 includes a mold body defining a parting surface 100. A number of molding areas 20 are defined at the parting surface 100. In the present embodiment, each of the molding areas 20 has a concave molding surface 201. In other embodiments, each of the molding areas 20 may have a convex molding surface or have a molding surface with other patterns.

Each molding surface 201 has an air flue 30 defined therein. The air flue 30 is formed at a position of the molding surface 201 which does not impact on the molded product. The air flue 30 goes through the imprinting mold 10. A first end 31 of the air flue 30 is exposed at the molding surface 201, a second end 32 of the air flue 30 is exposed at a bottom surface of the imprinting mold 10 (see FIG. 2). A diameter of the air flue 30 is in a range from about 0.5 microns to about 1.5 microns.

A breathable member 40 is filled in the first end 31 of the air flue 30 at the molding surface 201, and has an exposed surface smoothingly adjoining the molding surface 201. That is, an end shape of the air breathable member 40 conforms to that of the air flue 30 at the mold surface 201, thus it smoothes out the molding surface 201. In this way, the impact of the air flue 30 on the molding surface 201 can be reduced or even be avoided. The breathable member 40 is a nano-fabric or a mesh having nano particles embedded thereon. The nano-fabric can be made of a network of nanofibers. Micro-gaps still exist in the network of nanofibers and between the nano particles, thus it is breathable, and air bubbles in the molding product can be reduced or even be avoided. The breathable member 40 can prevent water molecules and other things to pass through.

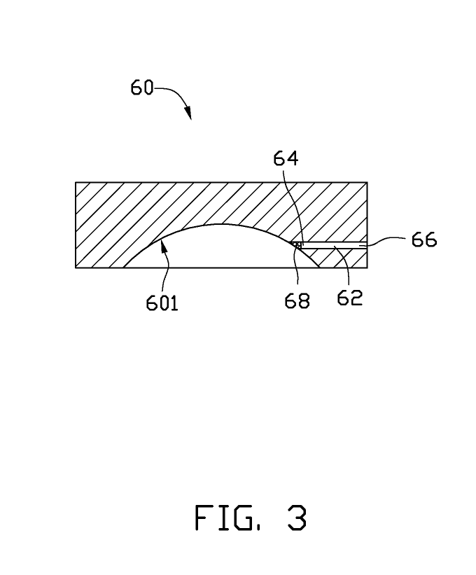

Referring to FIG. 3, an imprinting mold 60 in accordance with a second embodiment, is provided. The imprinting mold 60 is essentially similar to the imprinting mold 10 illustrated above, but differs from the imprinting mold 10 that the imprinting mold 60 includes only one molding surface 601, and an air flue 62 thereof has a second end 66 exposed at a lateral surface of the imprinting mold 60. A breathable member 68 fills a first end 64 of the air flue 62. The breathable member 68 has an exposed surface smoothingly adjoining the molding surface 201.

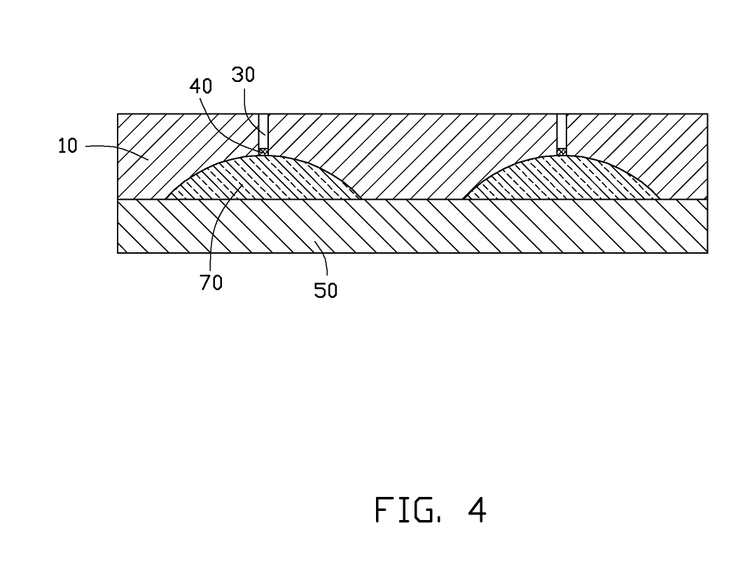

Referring to FIG. 4, an exemplary imprinting molding method using the imprinting mold 10 is introduced as follows.

First, a substrate 50 is provided. The substrate 50 can have a flat surface.

Second, a molding material 70 is applied on the substrate 50. The molding material 70 can be applied on the entire surface of the substrate 50 or on several areas on the substrate 50.

Third, the imprinting mold 10 is applied on the substrate 50 to shape the molding material 70. The imprinting mold 10 allows air into the molding material 70, the imprinting mold 10 is breathable. The breathable member 40 fills the air flue 30 to smooth the molding surface in the imprinting mold 10.

After separating the substrate 50 and the imprinting mold 10, a number of molding products can be obtained.

It is understood that the above-described embodiments are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. An imprinting mold, comprising a mold body comprising:
a top molding surface;
an air flue formed through the mold body, the air flue comprising a first end exposed at the top molding surface, and a second end; and
a breathable member filled in the first end of the air flue, the breathable member having an exposed surface smoothingly adjoining the molding surface.

2. The imprinting mold of claim 1, wherein the top molding surface is a concave molding surface.

3. The imprinting mold of claim 1, wherein a diameter of the air flue is in a range from about 0.5 microns to about 1.5 microns.

4. The imprinting mold of claim 1, wherein the second end of the air flue is exposed at a bottom surface of the mold body.

5. The imprinting mold of claim 1, wherein the second end of the air flue is exposed at a lateral surface of the mold body.

6. The imprinting mold of claim 1, wherein the breathable member is comprised of nano-fabric, the nano-fabric including a plurality of nanofibers and a plurality of micro-gaps between the nanofibers.

7. The imprinting mold of claim 1, wherein the breathable member is a mesh having nano particles embedded therein, the breathable member comprising a plurality of micro-gaps between the nano particles.

8. An imprinting molding method, comprising:
providing a substrate;
applying a molding material on the substrate;
pressing an imprinting mold on the substrate, the imprinting mold comprising a mold body including: a molding surface to shape the molding material; an air flue defined through the mold body, the air flue comprising a first end exposed at the molding surface, and a second end; and a breathable member filled in the first end of the air flue, the breathable member having an exposed surface smoothingly adjoining the molding surface; and
removing the substrate and the imprinting mold.

9. An imprinting mold comprising a mold body including:
a molding surface;
an air flue defined through the mold body, the air flue comprising a first end exposed at the molding surface; and
a nano-fabric member filled in the first end of the air flue, the nano-fabric member having an exposed surface smoothingly adjoining the molding surface, the nano-fabric member comprised of a network of nanofibers.
